(19) United States
(12) Patent Application Publication
(10) Pub. No.: US 2022/0358199 A1
(43) Pub. Date: Nov. 10, 2022

(54) CERTIFICATION SYSTEM AND DEVICE WITH AUTHENTICATION BETWEEN TERMINALS FOR THE RELEASE OF AN ELECTRONIC PADLOCK IMPLEMENTED BY A COMPUTER PROGRAM

(71) Applicants: José Marcos NABHAN, Cianorte - PR (BR); Vinicius Batistela NICOLETTI, Cianorte - PR (BR)

(72) Inventors: José Marcos NABHAN, Cianorte - PR (BR); Vinicius Batistela NICOLETTI, Cianorte - PR (BR)

(21) Appl. No.: 17/609,767

(22) PCT Filed: Dec. 17, 2020
(86) PCT No.: PCT/BR2020/050556

§ 371 Date: Nov. 8, 2021

(30) Foreign Application Priority Data
Jan. 30, 2020 (BR) BR10 2020 0019759

(51) Int. Cl. G06F 21/33; G06Q 50/16

(52) U.S. Cl. CPC G06F 21/33; G06Q 50/163

(57) ABSTRACT

Certification device with authentication between terminals for the release of an electronic padlock implemented by a computer program comprising an operating concept in which a machine-readable medium is provided that stores a computer program executed by at least one processing unit of a certification device synchronized to at least one smart device, such as smartphones, for example, by means of a network for authentication between the terminals and release of the remote lock of the certification device and provision of contextual data from central information terminal in which the first and second processing circuits are configured to generate a record of each associated access with information from the same real estate.

### INTRODUCTION

This disclosure is inherent to a certification device with a storage compartment for access keys for external use, or preferably installed in a place with external access in relation to real estate property through a horizontal projection handle, equipped with a certification system with a view to managing and validating the use of keys or similar devices that store, so that a data record is created at each access, to smart networked devices for authentication between terminals from a central information terminal (TCI) and certification with a storage compartment for access keys for external use, in which the first and second processing circuits are configured to generate a record of each access associated with the information of the same real estate, i.e., associated with the information of the corresponding estate.

Communication between the certification device, the central information terminal (TCI) and other terminals registered in the system, such as, for example, the owner's mobile phone, is given by computational means, integrating and making the various terminals interactive with the software embedded in the certification device.

Constructively, it is a certification device with compartment for storing access keys for external use with an embedded computer program, equipped with an alphanumeric keyboard and a means for identifying keys or stored opening devices. Access is made possible by a digital camera for facial recognition, barcode reader, digital reader for in-person opening or chip-card reader for identification and opening via chip card and infrared or Bluetooth reader for communication with smartphones. The certification device is also equipped with a rechargeable battery and respective solar panel and USB connection, which is also dedicated to data communication and battery and/or communication LED indicator. We recommend fixing it to an external area using the fixation handle which, as it is horizontally projected, keeps the certification device's access panel vertical.

### DESCRIPTION OF THE STATE OF THE ART

Sharing data across multiple devices is an increasingly popular feature. The data sharing feature is implemented by updating entire files and, in some cases, entire sets of files specified for synchronization across multiple devices.

The technical state teaches, for example, system and method for managing access to safes that hold real estate property keys and systems for potential buyers.

In searches carried out in the state of the art, it was possible to find documents involving several concepts, of which, those whose operation obey dissimilar concepts and not similar to the ones in this report, the following have been selected:

Document US2018/0190056 reveals system and method inherent to a wireless safe and a key that informs its location to a remote device, and which sends an alert to that remote device if it moves outside a predetermined threshold.

From the claim table, a wireless safe system for storing a key in real estate property is inferred, comprising: a wireless safe, the wireless safe composed of a first Bluetooth interface, a tray, an operable microprocessor to deploy and retract the tray controlling a motor, and a power supply, the wireless safe configured to pair with a mobile device through the first Bluetooth interface and to communicate with a remote device through a mobile device data interface, the wireless lockbox still configured to receive information from the remote device to determine if the mobile device is allowed to command the microprocessor to deploy and retract the tray; and a key configured to fit inside the tray and comprising a second Bluetooth interface, the key configured to pair with the mobile device via the second Bluetooth interface and collect data about the movement of the key, the key further configured to transmit the data to the device remote via the data interface.

Claim 9 of the document provides for a body portion configured to unlock a door; a power supply; a microprocessor; and a Bluetooth interface configured for docking with a wireless safe and a mobile device.

As for the method, claim 17 provides for detecting the location of a home key, comprising: receiving a notification that a wireless safe has been turned on, in which notification is received from the wireless safe through a connection of data from a mobile device to which the wireless safe is paired via Bluetooth; sending an indication to the wireless safe that a user of the mobile device is approved to access the wireless safe, using the key composed of a Bluetooth interface configured to pair with the mobile device and send information through the data connection and the key configured to collect data about its location; receiving key data about key location via mobile device data connection.

Document U.S. Pat. No. 9,734,646 discloses a system that includes a device to access the system by a potential buyer who it has a location determining subsystem.

From the claims, it follows device and subsystem determining location; a server with a set of listings regarding currently available real estate; a pre-approved loan obtained by the buyer and having a pre-approved loan amount; as well as a method comprising that the buyer received a pre-approved loan.

Unlike document U.S. Pat. No. 9,734,646 B1, the object of this report is not related to the pecuniary payment of any purchase or financial registration approval and, unlike this and document US2018/0190056 A1, it generates a record of each access associated with the information of the same real estate property with a view to facilitating the process of choosing the real estate property by the potential buyer or the buyer by the seller, solving the registration problem that is automatically produced from that person's access to the real estate property being visited.

In a disclosed mode, a certification system with authentication between terminals for wireless electronic lock release allows sales agents to communicate with a central control terminal, obtaining registration data of each access associated with the information of the same real estate property, which can be sent in real time during the customer's visit to the location where the certification device is installed. The sales agent and the potential customer will use smart devices such as smartphones, for example, with wide area network capability or Bluetooth, for authentication between terminals from a central information terminal (TCI) and certification with a compartment to store access keys for external use in which the first and second processing circuits are configured to generate a record of each access associated with the information of that same real estate.

In another form of certification system with authentication between terminals to release an electronic lock, a user can reach a place where a certification device is installed and receive contextual data referring to at least one real estate property of interest, preferably the one where it is installed. If necessary, the user can schedule visits or request access via an app.

### BRIEF DESCRIPTION OF THE INVENTION

The certification device with a storage compartment for access keys for external use, or preferably installed in an externally accessible place in relation to real estate, consists of a reinforced receptacle with a compartment for storing keys or similar devices, equipped with an embedded computer program and computerized system for wireless or substitute integration, which allows a certification protocol to be generated with authentication between terminals to release an electronic lock and record of each access associated with the information of a given real estate property, from a central terminal of information and networking.

Said device is equipped with an internal rechargeable battery by direct power, from a power source or by a solar panel as well as a support in the form of a handle, to attach to bars, gates or strategically established locations, preferably in outdoor areas of the real estate.

From an operational point of view, it is a device that synchronizes at least two computer terminals to the embedded software, providing data that may include passwords, private keys, certificates, secure notes, etc., with a view to certification with authentication between terminals and from a central information terminal (TCI) to release an electronic lock, generating a registration protocol for each access associated with information of the same real estate.

### DESCRIPTION OF THE DRAWINGS

Characterization of this model is given through representative drawings of the proposed solutions, which express the preferential ways of achieving the idealized product, basing the description through numerical references. Such figures are merely illustrative and may vary, as long as they do not deviate from what was initially claimed. Therefore:

FIGS. 1 and 2 show the constructive configuration of the certification device (1), showing the sensor (3) in person/infrared communication, the camera (8), the numeric keypad (7) and compartments (4 and 1′) for the internal circuits and the housing access key (not shown). Respectively, the handle (2) is shown in vertical and horizontal projection in relation to the fastener (2′), and indicative arrows inform the direction of displacement of the fastener (2′) of the handle (2) and the access key compartment (1′) in the two figures.

FIGS. 3 and 4 show the vertical and horizontal constructive solution of the handle (2) and respective fastener (2′), with emphasis on the positioning and direction of displacement of the access key compartment (1′).

FIG. 5 in bottom view, illustrates the positioning of the USB connections (5), connectors (6) for the battery and input (9) for the ID card chip.

FIG. 6 in top view, illustrates the positioning of the solar panel (13), considering the constructive solution in which the handle (2) projects horizontally.

FIG. 7 in block diagram, describes the flow of information from the synchronization and interconnection of at least three terminals, i.e., a central information terminal (10), a certification device (1) and a smart device (11), such as smartphones, for example, with wide area network (12) capability or Bluetooth.

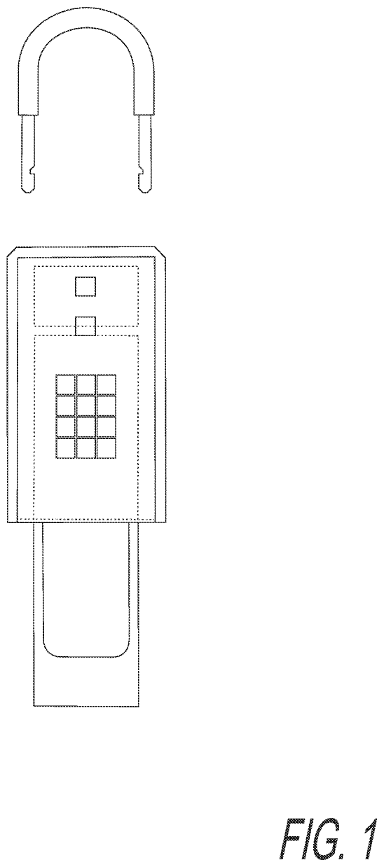

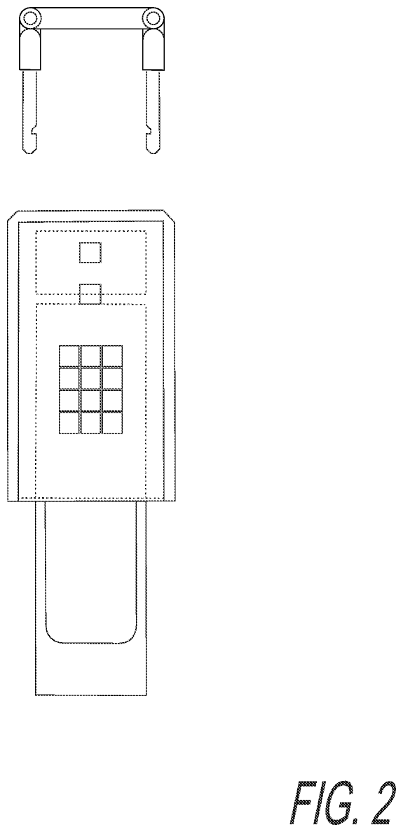

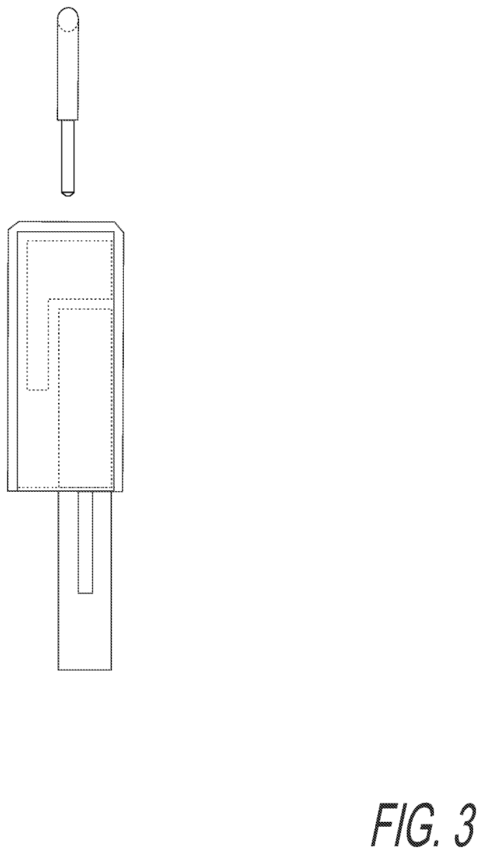

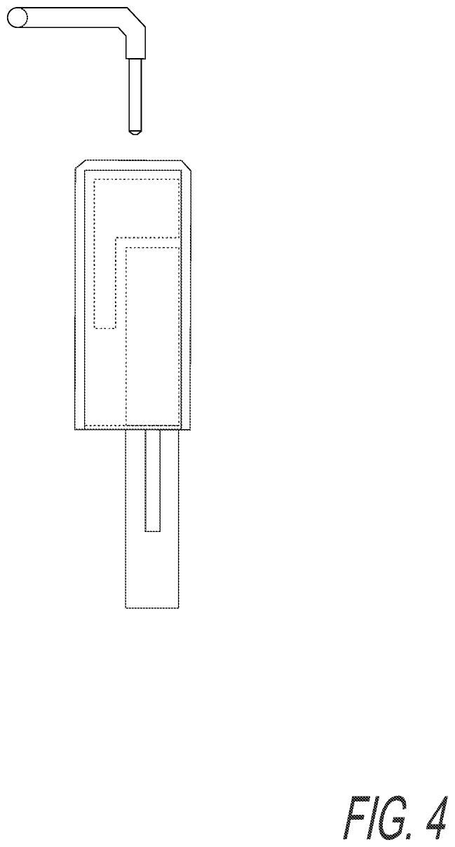

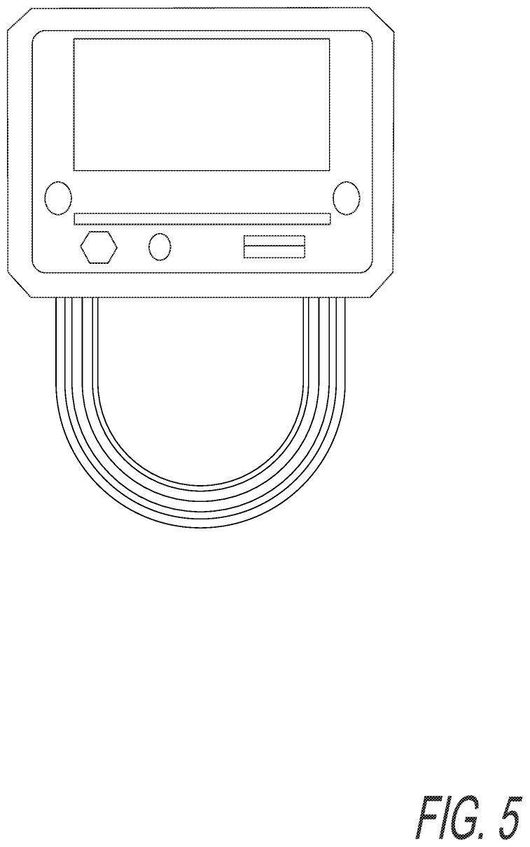

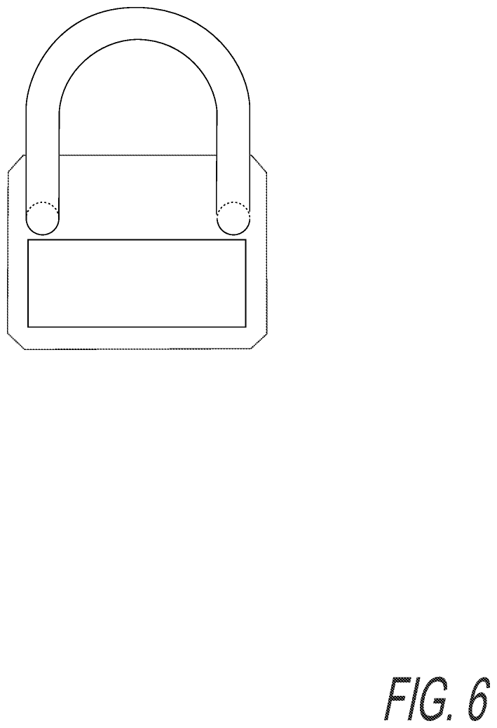

### DETAILED DESCRIPTION OF THE INVENTION

The following description refers in detail to the preferred embodiment of this model, as illustrated in the drawing examples with numerical references indicative of the elements and components illustrated along the proposed views, which also follow.

The terms “first” and “second” that precede the name of an element, for example, are used for identification purposes and to distinguish similar or related elements, results or concepts, and do not necessarily imply order, nor are the terms “first” and “second” intended to preclude the inclusion of elements, results or similar or related additional concepts, unless otherwise indicated.

Furthermore, it should be understood that the modalities disclosed herein include hardware and electronic components or modules that, for discussion purposes, can be illustrated and described as if most components were implemented only in hardware.

In this sense, a person skilled in the art would recognize, based on reading this detailed description, that in at least one modality, the electronic aspects of the technology disclosed here can be implemented in software. As such, it should be noted that various hardware and software-based devices, as well as various different structural components, can be used to implement the technology as disclosed herein.

It will be understood that the term “circuit”, as used herein, may represent an electronic circuit, such as an integrated circuit chip (or a part thereof), or may represent a function that is performed by a processing device, such as a microprocessor that includes a logical state computational terminal or another processing element (including a sequential processing device). A specific type of circuit can be an analog or digital circuit of some kind, although that circuit can be implemented in software by a logical state machine or a sequential processor. In other words, if a processing circuit is used to perform a desired function used in the technology disclosed herein (such as a demodulation function), there may not be a specific “circuit” that can be called a “demodulation circuit”; there would be a demodulation “function” that is performed by the software, since such possibilities are compatible with the principles of technology regarding a “circuit”.

The certification device (1) with authentication between terminals (10 and 11) described herein promotes the release of an electronic lock and the delivery of information about the real estate property in which it is installed, such as location, document status, sale price or location, territorial limits, etc., dispensing with conventional data transmissions and retransmissions, online searches and having the possibility of more than one user simultaneously.

The preferred mode of achieving the product allows the certification device (1) to communicate with smart devices (11), such as smartphones, for example with wide area network (12) capability or Bluetooth, the operator can change settings and information when and if necessary.

The system (1, 10, 11, 12) uses, in some modalities, information obtained from a GPS receiver associated with the certification device (1) or smart devices (11), such as smartphones.

As for the configuration, the system includes at least three terminals, i.e., the central information terminal (TCI) (10), the certification device (1) and at least one smart device (11), such as a smartphone, for example, in each one where the application software (APP) is installed, they can communicate each other and from the central information terminal (TCI) (10) by means of a long-distance network (12) (WAN) or substitute. The application (11) identifies itself to the central information terminal (TCI) (10) through user login credentials, remaining active on the smart device (11), such as a smartphone, for example, receiving notifications and data from the central information terminal (TCI) (10) in real time.

When accessing the certification device (1), the smart device (11) receives the identity of the embedded software, with the GPS location data provided by the software itself or by the smart device (11) which, if in range long-distance network (12) communication system (WAN), will retransmit the access event data to the central information terminal (TCI) (10), which identifies them in a general database in a pre-assigned serial of the certification device (1).

Any relevant contextual data can be sent to the smart device (11), which may include information about taxes, advertising, schools, including photos or videos that the system (1, 10, 11, 12) can store in the central terminal information (TCI) (10).

Upon accessing the certification device (1), the central information terminal (10) software identifies the real estate property listing information based on the pre-assigned serial of the corresponding certification device (1), which are communicated as part of the transmission.

Device (1) settings can be set by the operator, including blocking other operators from being able to view them. The system (1, 10, 11, 12) allows the operator to include, delete or change data in the central information terminal (10).

Constructively, the certification device (1) is provided with a handle (2) for fastening to window bars, for example, and is equipped with a conventional electrical charge storage. In an alternative solution, the power supply can adopt a solar panel (13).

In a preferred mode, the handle (2) projects horizontally so that the keyboard (7) of the certification device (1) corresponds to the best ergo metric position of use, i.e., it remains vertical.

The physical lock and release mechanism of the certification device (1) is controlled through gears similar to those on a conventional padlock system and can be activated mechanically or through a drive circuit controlled by the central information terminal (TCI) (10).

Preferably, above the keyboard, (7) there is an infrared sensor (3) and a digital camera (9) to notify of an external device (11), reading bar codes and taking picture, including to prevent vandalism.

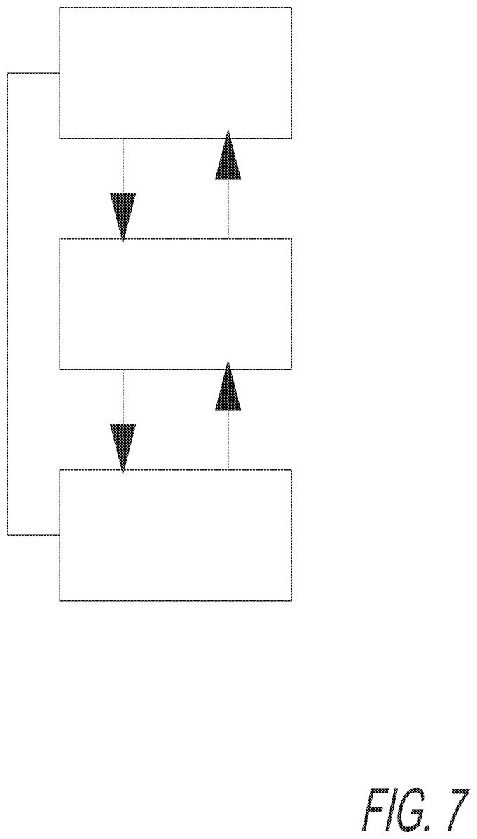

In a first mode, the certification system and device (1) is represented in a block diagram as proposed in FIG. 7, which is shown in communication with a central information terminal (10) and at least one smart device (11), as a smartphone, for example, in order to integrate the various terminals (12) to the network (10, 11).

In a preferred mode in this first mode, the certification device (1) is provided with USB (5 and 9) connectors and an identification card with a chip. Alternatively, the device (1) is provided with a keyboard (7) connected with a binary password system.

A serial interface is also included for the central information terminal (10) to communicate with other external devices (11), such as a separate laptop computer in the form of a PDA (Personal Digital Assistant) or other type of portable computing device that uses serial data link. For example, the serial interface can include an infrared (IR) port that communicates with a standard infrared port found on many PDAs.

The microprocessor (10) of the central information terminal (TCI) controls the operation of the certification device (1) according to the instructions stored in a commonly used memory device, such as a FLASH. Data such as counters and software variables or permanent data from the certification device (1), such as serial number, configuration information and so on, are stored in commonly used and unproven memory systems such as RAM and EEPROM. Many different types of microprocessors or microcontrollers can be used to configure the certification device (1) and many different types of memory devices can be used to store in volatile and non-volatile data, without departing from the principles disclosed herein.

In a preferred modality, the certification device (1) is equipped with a microprocessor that incorporates RAM memory, FLASH memory and EEPROM memory, equipped with a battery with a capacitor for operating electrical energy. It will be understood that an alternative electrical power source can be used, if desired, such as a solar panel (13) with the memory backup capacitor.

The certification device (1) also includes the internal compartments (1′ and 4) to store access keys, which can be accessed using the keyboard (7) or smart card with a standard chip or a substitute means, as well as for the internal circuits.

It will be understood that the release or locking mechanisms of the handle (2) and the internal compartment for storing access keys (1′) can be constructed of different types of mechanical or electromechanical devices without departing from the principles of technology disclosed here.

For the purposes of this report, an electronic key could be used as a type of secure memory device rather than a conventional smart card, which would also contain a memory device and even control logic circuits. As used here, the term “electronic key” can include a relatively simple device, such as a secure memory card and can mean a sophisticated device, such as a laptop or smartphone that has a wireless communication circuit to send and receive messages from other devices.

Referring to the block diagram in FIG. 7, access to the keyboard (7) is given through passwords. It is an electronic key that includes a microprocessor with built-in memory and interface components whose screen is sensitive to the touch, particularly if the electronic key is a smartphone, i.e., the electronic key may be in the form of a smart phone (11).

Referring still to the block diagram of FIG. 7, it shows the flow from the central information terminal (10) to a software routine that delivers the data. The information flow as shown determines whether there was interaction between the certification device (1) and the other registered terminals (10, 11), authenticating at the central terminal (10) through a received message, usually from the electronic key, password or substitute. If the answer is negative, the control logic will return to perform other functions, maintaining the remote block.

If the answer is positive, the control logic will authenticate the synchronization and send a request to the central information terminal (TCI) (10) to release the certification device (1). In this step, the terminal (10) identifies the location of a certification device (1).

The certification device (1) remains linked to the data of the real estate property where it is installed and the central information terminal (10) receives a communication from a certification device (1) and, once the synchronization is authenticated, it releases the physical access and real estate property information.

In the information flow between the devices (1, 10, 11) the central information terminal (10) determines whether the certification device (1) is associated or not with a certain real estate property. If the answer is yes, the control logic will return to run the release routines. Otherwise, the central information terminal (TCI) (10) will send a blocking message to the certification device (1).

Assuming that the identification is authenticated, the central information terminal (10) will release access to the real estate property and to certain database information.

After the user completes the access, the central information terminal (10) will allow the option of continuity of interaction in relation to other real estate property and another certification device (1). If the option is made for other real estate, the logical flow will be directed to the new flow and the user will be able to continue selecting other certification devices (1). Otherwise, the logic flow will be directed to complete the routine, blocking the certification device (1).

It will be understood that the terms “lock” and “lock device” have essentially the same meaning throughout this report. In general, a purely mechanical lock can be used, but an electromechanical locking device is also contemplated, such as the keyboard (7) shown in the diagram in FIG. 7, by means of a password combination with alphanumeric characters.

In general, the remote locking system from the central information terminal (TCI) (10) can also contemplate pairing the certification device (1) with smart devices (11), such as smartphones, for example with a wide area network capability or Bluetooth (12).

The Bluetooth protocol is such that, once one of the devices (1, 10) connects to another or other devices (11), data is exchanged automatically, provided that the smart device (11) is authenticated at the central information terminal (10). Otherwise, the central information terminal (10) disconnects the wireless communication link (12) and returns to the original blocking mode.

The APP program in the smart device (11) receives the authentication from the central information terminal (TCI) (10). The operator will now connect to the central information terminal (10) using the network communication circuit (12) of the smart device (11).

In any case, once the device is authenticated (11), the contextual data will be requested from the central information terminal (TCI) (10) and the logical flow allows this stored data to be made available to the smart device (11).

Once the app is started on the smart device (11), the operator will activate the central information terminal (10). A wireless link (12) is established between the certification device (1) and the smart device (11), such as smartphones, e.g. with wide area network capability (12), and the operator will authenticate the smart device (11) at the central information terminal (10) and the credentials of the smart device (1) will be sent.

Finally, some modalities include electronic components such as microprocessors and memories that store computer program instructions in a computer-readable medium. Some examples of such computer-readable media include RAM, ROM, read-only compact discs (CD-ROM), recordable compact discs (CD R), rewritable compact discs (CD-RW), read-only digital versatile discs (e.g. DVD-ROM, double-layer DVD-ROM), a variety of recordable/rewritable DVDs (e.g. DVD-RAM, DVD RW, DVD+RW, etc.), FLASH memory (e.g. SD cards, MINI-SD cards, MICRO-SD cards, etc.), magnetic and/or solid-state hard disks, read-only and writable Blu-Ray® disks, ultra-density optical disks, any other optical or magnetic media, and floppy disks. The computer-readable media can store a computer program that is executable by at least one processing unit and includes sets of instructions for performing various operations.

Although this model has been described with reference to several specific details, one skilled in the art will recognize that it can be incorporated into other specific forms without departing from the object itself considered. The specific operations of these processes may not be performed in the exact order shown and described. Specific operations may not be performed in a continuum of operations and different specific operations may be performed in different modalities. In addition, the process can be implemented using multiple sub-processes or as part of a larger macro process. Thus, one skilled in the art would understand that the present model is not to be limited by the above illustrative details but is to be defined by the attached claims.

1- Certification device with authentication between terminals consisting of a horizontal projection handle for fixing the device with the keyboard in the vertical position, comprising:
a voltaic panel for supplying electrical energy to a charge accumulator in common use;
at least one central information terminal (TCI) that pairs the certification device with network-capable smart devices, having a first processing circuit, a first memory circuit and a first wireless communications circuit in which the terminal information center (TCI) is assigned to a first specific real estate;
at least one portable communication device such as smartphones, for example, to configure a second processing circuit, a second memory circuit, a screen, a data input circuit, and a second wireless communications circuit;
at least one certification device with compartment for storing external use access keys and blocking to protect a specific real estate, wherein said first and second processing circuits are programmed with computer code to perform functions of:
i) use said first wireless communications circuit of said central information terminal (TCI) to send a first message containing information of interest regarding said specific real estate property and
i) generate a record of each access associated with information from the same real estate property and
ii) generating visual information on the screen of said portable communication device, and
iii) synchronizing the certification device (1) to smart devices (11) in a network (12) for authentication between terminals from a central information terminal (10) (TCI), characterized in that the first and second processing circuits are configured to generate a record of each associated access linked to the information of the same real estate.
